(19) United States
(12) Patent Application Publication
(10) Pub. No.: US 2016/0078557 A1
(43) Pub. Date: Mar. 17, 2016

(54) SETUP OF A COMPUTER SYSTEM THAT EXECUTES AN ACCOUNTING PROGRAM

(71) Applicant: ORACLE INTERNATIONAL CORPORATION, REDWOOD SHORES, CA (US)

(72) Inventors: Ashish Kumar, Belmont, CA (US); Carolyn Luk, Hillsborough, CA (US); David Haimes, Belmont, CA (US); Ramakanth Pachika, Hyderabad (IN)

(73) Assignee: ORACLE INTERNATIONAL CORPORATION, REDWOOD SHORES, CA (US)

(21) Appl. No.: 14/553,097

(22) Filed: Nov. 25, 2014

Related U.S. Application Data
(60) Provisional application No. 62/049,951, filed on Sep. 12, 2014.

(51) Int. Cl. G06Q 40/00; G06F 17/30

(52) U.S. Cl. CPC G06Q 40/12; G06F 17/30424

(57) ABSTRACT

Setup of accounts in accounting software is automated, based on user input on (1) a name of an account of a specific type, and (2) a specific value to be used to identify the account uniquely, among other accounts of the specific type. The account's name is used by one or more computers to automatically look up N unique values that identify N entities of an organization. Then, a pattern of segments that defines an account identifier is automatically used by the one or more computers, to insert into the pattern the specific value and each of the N unique values, to obtain N account identifiers. Thereafter, N tuples are automatically formed by the one or more computers and stored in a table, each tuple comprising one of the N account identifiers, and the account's name. Subsequently, N accounts are setup in the accounting program, based on the N tuples.

### CROSS-REFERENCE TO PROVISIONAL APPLICATION

This patent application claims priority under 35 USC §119 from U.S. Provisional Application 62/049,951 entitled “SETUP OF A COMPUTER SYSTEM THAT EXECUTES AN ACCOUNTING PROGRAM” filed on Sep. 12, 2014 by Ashish Kumar, Carolyn Luk, David Haimes and Ramakanth Pachika which is hereby incorporated by reference herein in its entirety.

### FIELD

This patent application relates to improvements in the setup of a computer system that executes an accounting program.

### BACKGROUND

It is known for a human user to setup (or organize) accounting software executing in a computer system, by inputting information in a spreadsheet of a workbook by use of spreadsheet software (e.g. MICROSOFT® Excel), and then uploading the information to the accounting software. One example of a prior art process is described as “Rapid Implementation” in a document entitled “ORACLE® Cloud Setting Up Financials: Quick Start”, Release 13.1, Part Number E38515-01, published August 2013, available from Oracle Corporation, Redwood Shores, Calif. 94065, which document is incorporated by reference herein in its entirety as background. For additional information see another document entitled “Oracle® Fusion Accounting Hub Implementation Guide”, 11g Release 7 (11.1.7), Part Number E20374-07, published March 2013, available from Oracle Corporation, Redwood Shores, Calif. 94065, which document is also incorporated by reference herein in its entirety as background.

Rapid implementation uses user input in one or more spreadsheets to cause a computer system to create certain accounting structures such as a ledger, a chart of accounts, legal entities, and business units. In the accounting software, each account in the chart accounts is identified by an identifier that is segmented into multiple segments, with user input necessary to identify each value in each segment of the identifier. For example, user input in a spreadsheet (or in a screen of a graphical user interface) may identify an account using the identifier 01-2900-500-123 which is divisible into four fields (“segments”) separated by the dash sign “-”. Each of the four values may be selected by user input from among four sets of values, predefined as valid values of the four segments.

One issue with such a prior computer system is that user input identifying each value for each segment, in a segmented identifier of each account, becomes laborious when a large number of accounts need to be setup. For example when an enterprise operates in ten countries, setting up a single account (e.g. the retained earnings account) requires user input to be provided ten times for ten legal entities. In the just-described example, if there are three business units within each legal entity, user input may be needed thirty times, when an account (e.g. retained earnings account) is being setup for each business unit.

The inventors of the current patent application note that without user input to supply an identifier for each account to be setup, there appears to be no way for a computer system to know which specific values in multiple sets of valid values of corresponding multiple segments are to be combined to form a segmented identifier. Hence, there is a need for improvement in the setup of a computer system that executes accounting software, as described below.

### SUMMARY

In several described embodiments, setup of accounts in accounting software is automated, based on user input on (1) a name of an account of a specific type, and (2) a specific value to be used to identify the account uniquely, among other accounts of the specific type. The account's name is used by one or more computers to automatically look up N values that identify N entities of an organization. Then, a pattern of segments that defines an account identifier (“account ID”) is automatically used by the one or more computers, to insert at least the specific value into one segment of the pattern, and each of the N values into another segment of the pattern, to obtain N account identifiers. If a pattern includes one or more segments (“additional segments”) in addition to the just-described two segments, a default value is inserted into each additional segment, in obtaining the N account identifiers.

Thereafter, N tuples are automatically formed by the one or more computers and stored in a document in non-transitory computer readable storage media (e.g. disk or flash memory), each tuple comprising one of the N account identifiers labeled with a first predetermined label (e.g. the label “AccountSegments”), and the account's name labeled with a second predetermined label (e.g. the label “AccountName”). The document (e.g. in eXtended Markup Language, or XML) is transmitted to a server that executes an accounting program. The server stores the N tuples in a table in a database used by the accounting program, each of the N tuples being stored in a row of the table, the table comprising a first column for the account identifier and a second column for the account name. Subsequently, N accounts are automatically setup in the accounting program, based on the N tuples, eliminating the need to provide user input N times for the N accounts.

It is to be understood that several other aspects of the described embodiments will become readily apparent to those skilled in the art from the description herein, wherein it is shown and described various aspects by way of illustration. The drawings and detailed description below are to be regarded as illustrative in nature and not as restrictive.

### BRIEF DESCRIPTION OF THE DRAWINGS

FIG. 1 illustrates, in a flow chart, acts 111-115, 118 and 119 performed by an account ID generator 110 in one or more computer(s) 100 by use of one or more processors programmed with a sequence of instructions of software stored in one or more non-transitory memories, in exemplary embodiments in accordance with the invention.

FIG. 2A illustrates a spreadsheet 210 via which user input is received by computer(s) 100 executing spreadsheet software: in column 212 on a specific value to be used to identify an account uniquely among multiple accounts of a specific type, and in column 211 on a type and a name (or subtype) of the account, as per respective acts 111 and 112 of FIG. 1.

FIG. 2B illustrates a map 220 used by the one or more computer(s) 100 in act 113A of FIG. 1, to lookup a level of an organization using an account name.

FIG. 2C illustrates, in spreadsheet 210 of FIG. 2A, a drop-down box 230 displaying a list of items, for user selection of a specific account type and account name combination, as one of the items in the list.

FIG. 3A illustrates a spreadsheet 330 that is searched by the one or more computer(s) 100 in some embodiments of act 113B of FIG. 1 to identify entities of the organization at a ledger (or country) level, or at a legal responsibility level.

FIG. 3B illustrates, a document 350 created by the one or more computer(s) 100 in exemplary embodiments in accordance with the invention, including three tuples 351, 352 and 353 created at a ledger level, wherein each tuple includes at least an account identifier and an account name.

FIGS. 3C and 3D illustrate, in document 350 six tuples 361-366 created by the one or more computer(s) 100 at a legal entity level, and each tuple includes at least an account identifier and an account name.

FIG. 4 illustrates, in a spreadsheet 400, a pattern that defines an account identifier, in exemplary embodiments in accordance with the invention, with a sequence of segments shown vertically in column 401, and display width of each segment shown in column 402.

FIG. 5A illustrates another spreadsheet 500 that is searched by the one or more computer(s) 100 in some embodiments of act 113B of FIG. 1, to identify entities of the organization at a business unit level.

FIGS. 5B-5D illustrate, in a document 550 nine tuples 551-559 created by the one or more computer(s) 100 at a business unit level, wherein each tuple includes at least an account identifier and an account name.

FIG. 6A illustrates, in a block diagram, hardware portions of one or more computers 100 and server 150 programmed with software portions of the type illustrated in FIG. 6B or 6C to perform one or more acts illustrated in FIG. 1 in some embodiments.

FIGS. 6B and 6C illustrate, in block diagrams of alternative embodiments, one or more computers 100 and server 150 of the type shown in FIG. 6A programmed with software to perform one or more acts illustrated in FIG. 1, with account ID generator 110 that is either internal to or external to accounting program 190.

### DETAILED DESCRIPTION

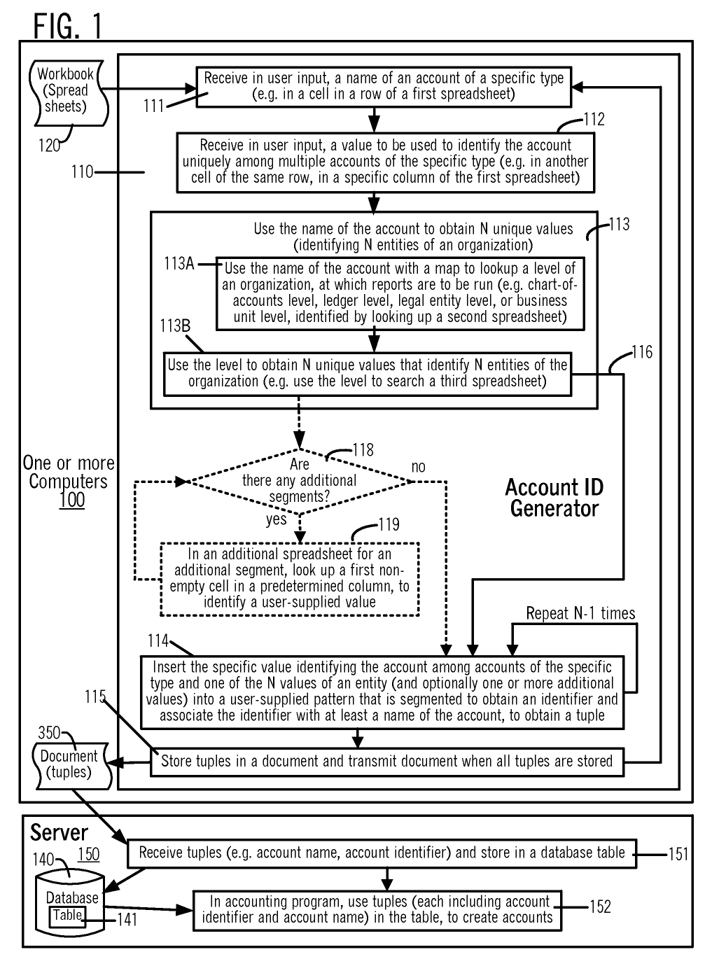

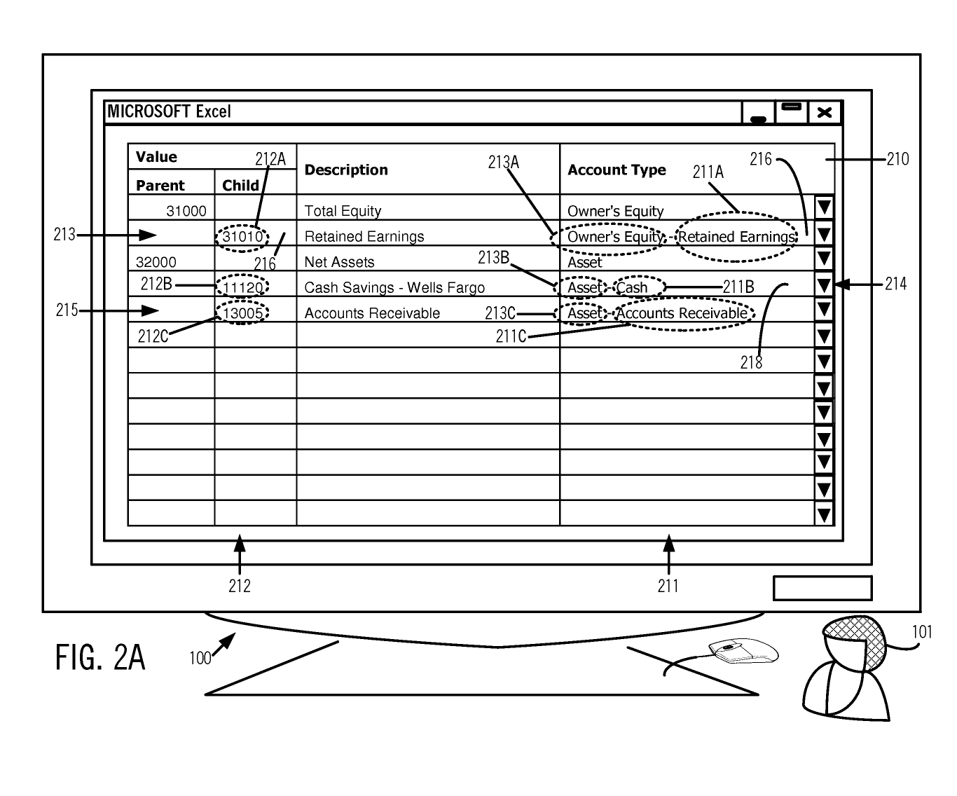

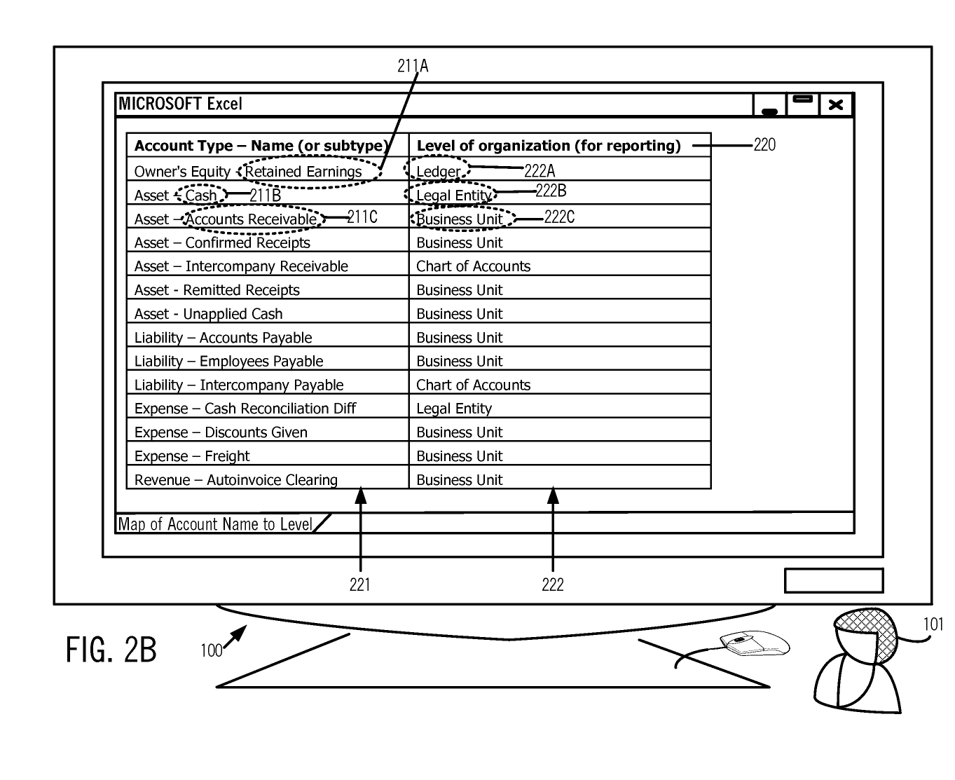

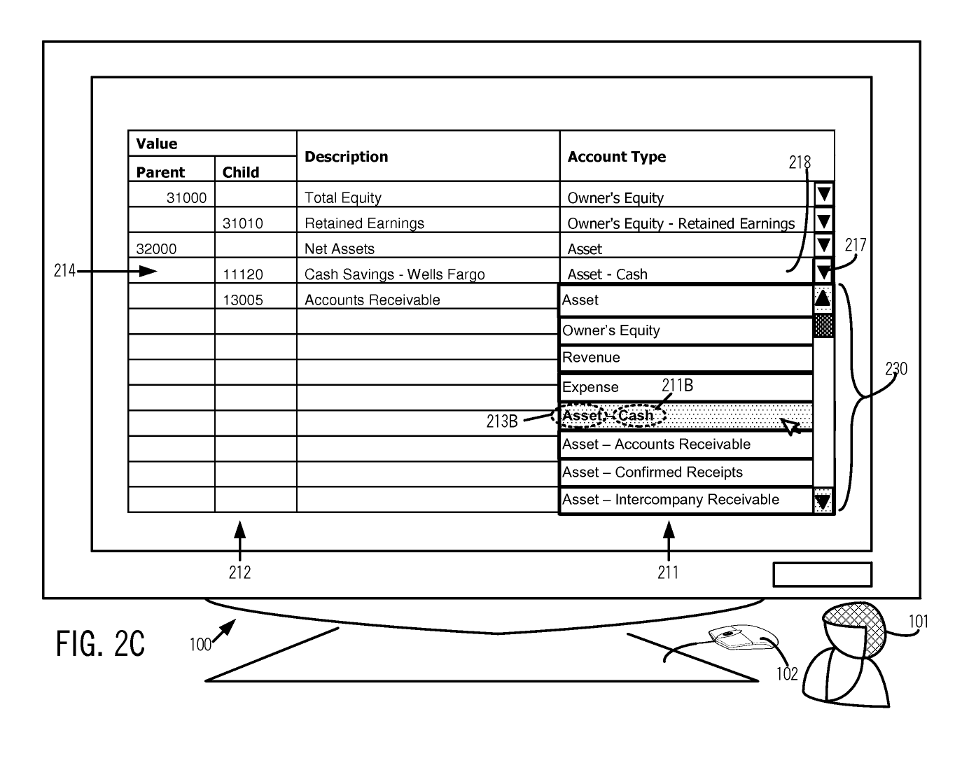

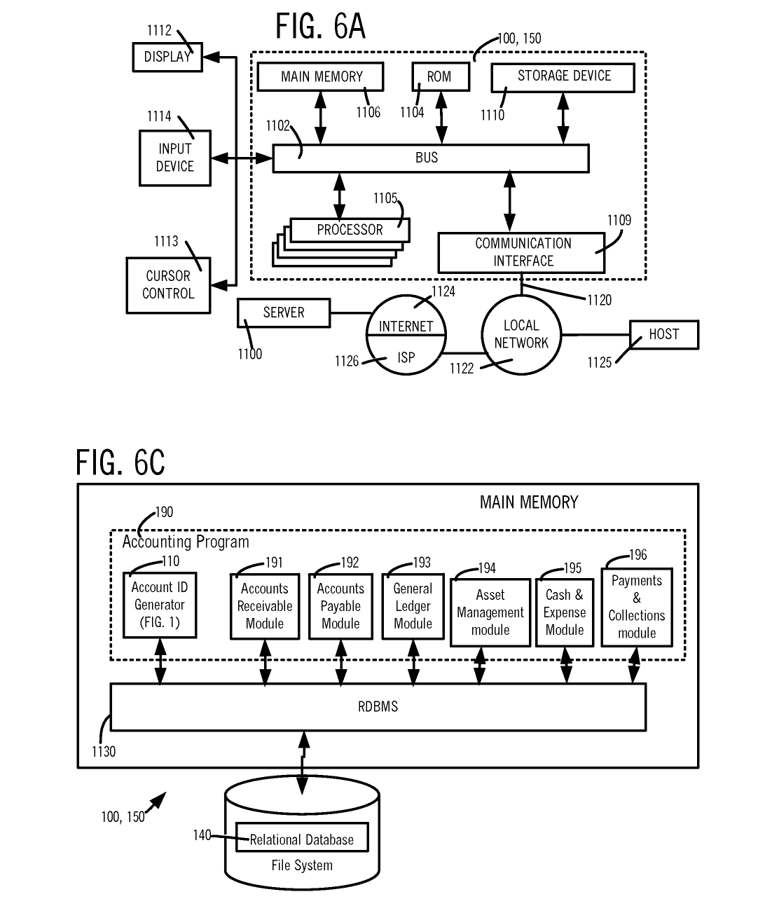

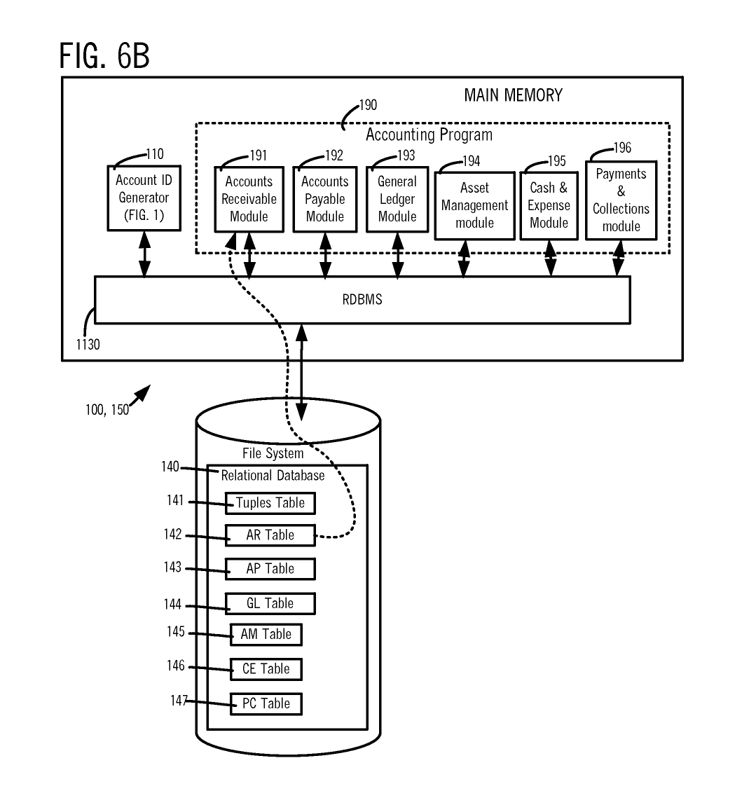

Several described embodiments improve the functioning of a computer system that facilitates setup of accounts in an accounting program 190 (FIG. 6B) executing in a server 150, by use of one or more computer(s) 100 to receive user input on a name of an account of a specific type as per act 111 in FIG. 1, and further receive user input on a specific value to be used to identify the account uniquely, among other accounts of the specific type as per act 112. The just-described two user inputs are received from a user 101 (FIG. 2A) by the one or more computer(s) 100 executing spreadsheet software (such as MICROSOFT® Excel) in some exemplary embodiments, via two columns 211 and 212 in a common row of a spreadsheet 210 (see FIG. 2A) which is included in a workbook 120 (FIG. 1).

Specifically, in act 111 (FIG. 1), one or more computer(s) 100 receive an account's name 211A via a cell 216 which is located in row 213 and column 211 of spreadsheet 210 (FIG. 2A), e.g. the name “Retained Earnings” is received by spreadsheet software executing in the one or more computer(s) 100. In the example illustrated in FIG. 2A, the one or more computer(s) 100 additionally receive, via cell 216, a specific type 213A of the named account, e.g. the type “Owner's Equity”. Thus, the name of the account and the type of the account are received in a single cell 216 in row 213 of spreadsheet 210. In the example of FIG. 2A, account type 213A and account name 211A are separated from one another by a hyphen, or dash namely “-” which can be used by the one or more computer(s) 100 to extract the account type and account name from the input “Owner's Equity—Retained Earnings” received via cell 216. In alternative embodiments, user input on account type 213A and account name 211A is received individually, in separate cells of row 213, as readily apparent in view of this detailed description.

Moreover, in act 112 (FIG. 1), one or more computer(s) 100 receive a specific value 212A via another cell 216 which is also located in row 213, in column 212 of spreadsheet 210 in FIG. 2A, e.g. the specific value “31010” is received by spreadsheet software executing in the one or more computer(s) 100. As cells 216 and 215 are within the same row 213, the specific value “31010” received via cell 216 is to be used to uniquely identify the account named “Retained Earnings” received via cell 216, e.g. among multiple accounts of type “Owner's Equity”.

In some embodiments illustrated in FIG. 2C, clicking of an arrow 217 in cell 218 of row 214, on operation of a button on mouse 102 by user 101, reveals a drop-down box 230 included in spreadsheet 210. Drop-down box 230 displays a list of two kinds of items: a first kind of items (such as “Asset”, “Owner's Equity”, “Revenue”, “Expense”) which identify only account types (e.g. natural types of accounts), and a second kind of items which identify combinations of account type and account name (such as “Asset—Cash”, “Asset—Accounts Receivable”, “Asset—Confirmed Receipts”, “Asset—Intercompany Receivable”, etc.). All items in box 230 are predetermined in spreadsheet 210, and user 101 simply selects one of these items by operating mouse 102, such as the item “Asset—Cash” which includes “Asset” as the account type 213B and “Cash” as the account name 211B, separated from one another by a hyphen. In this manner, in act 111, one or more computer(s) 100 receive account type 213B and account type 211B both in a single cell 218, which is located in column 211 and in the row 214. Also, as noted above, a value in another cell in the same row 214 in column 212 is received in act 112, e.g. via an input device 1114 (FIG. 6) which includes alphanumeric (e.g. of a keyboard). Column 211 is labeled in spreadsheet 210 of FIG. 2C as “Account Type” although this column includes (in addition to items of the first kind), one or more items of the second kind that identify a combination of account name and account type. Acts 111 and 112 may be performed in any order relative to one another, by one or more computer(s) 100 in response to user input.

After acts 111 and 112 are performed, in an act 113 (FIG. 1), the one or more computers 100 execute a macro in the spreadsheet software (e.g. in response to operation of a button in spreadsheet 210 by user 101). The macro is configured in workbook 120 to cause the one or more computer(s) 100 to use an account's name, e.g. “Retained Earnings” to automatically obtain N values that identify N entities of an organization respectively, at which financial reporting is to be done and journals are to be balanced. The organization can include entities at different levels, e.g. in a hierarchy. For example, an organization may have a first number of entities at a country level (or ledger level), and a country may have a second number of entities of the organization at a legal responsibility level, and a legally responsible entity (also called simply “legal entity”) may itself contain a third number of entities at a business unit level, and so on.

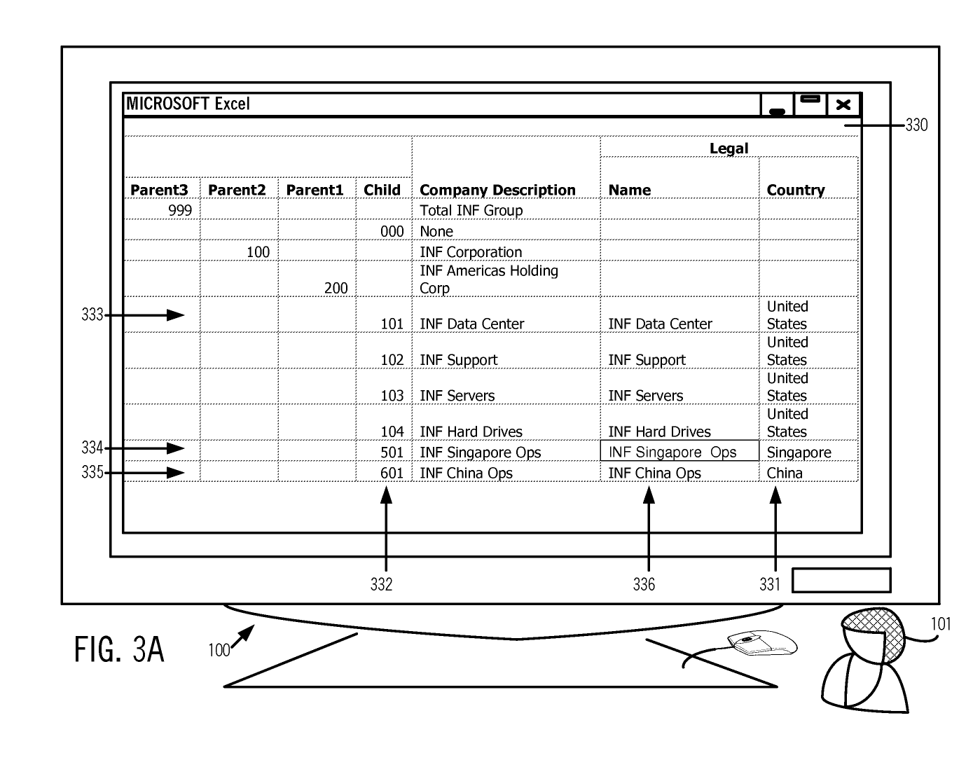

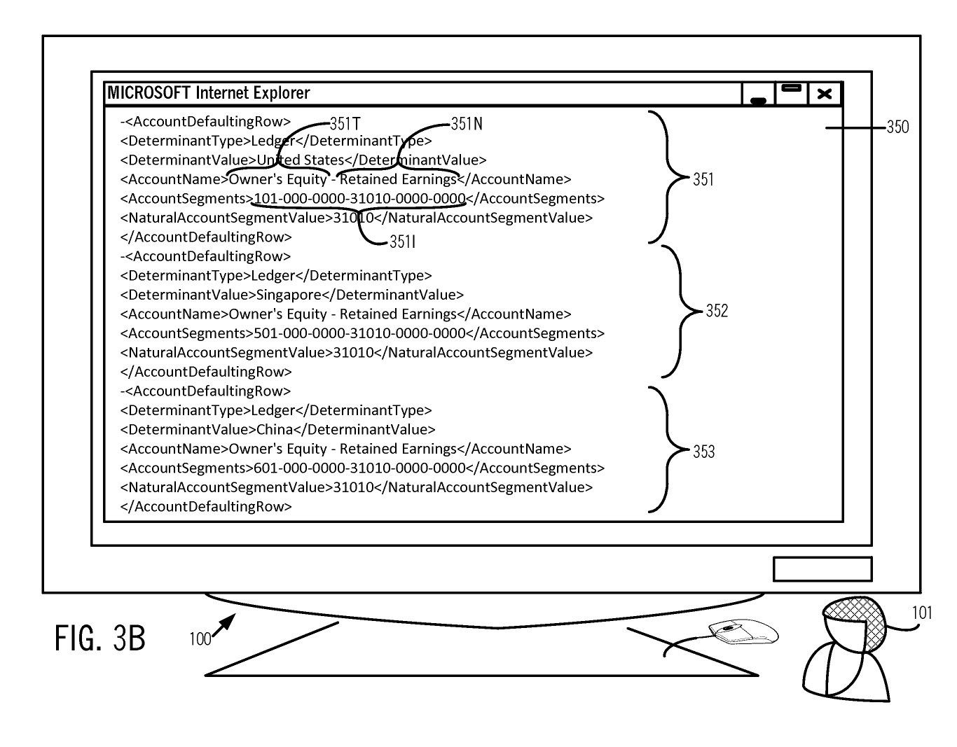

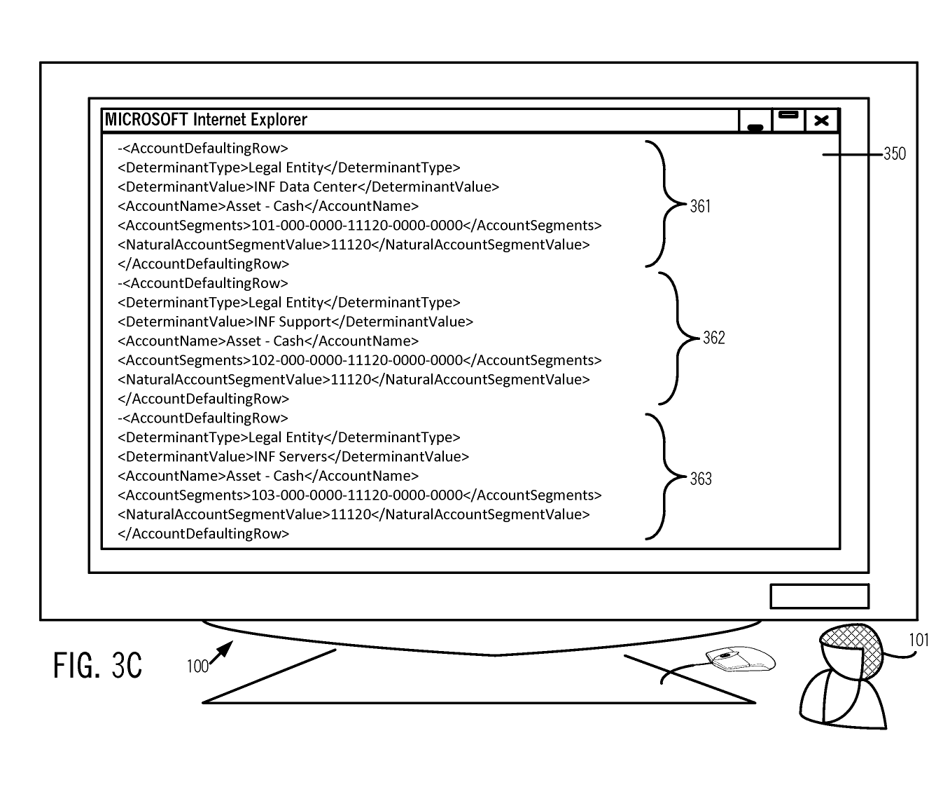

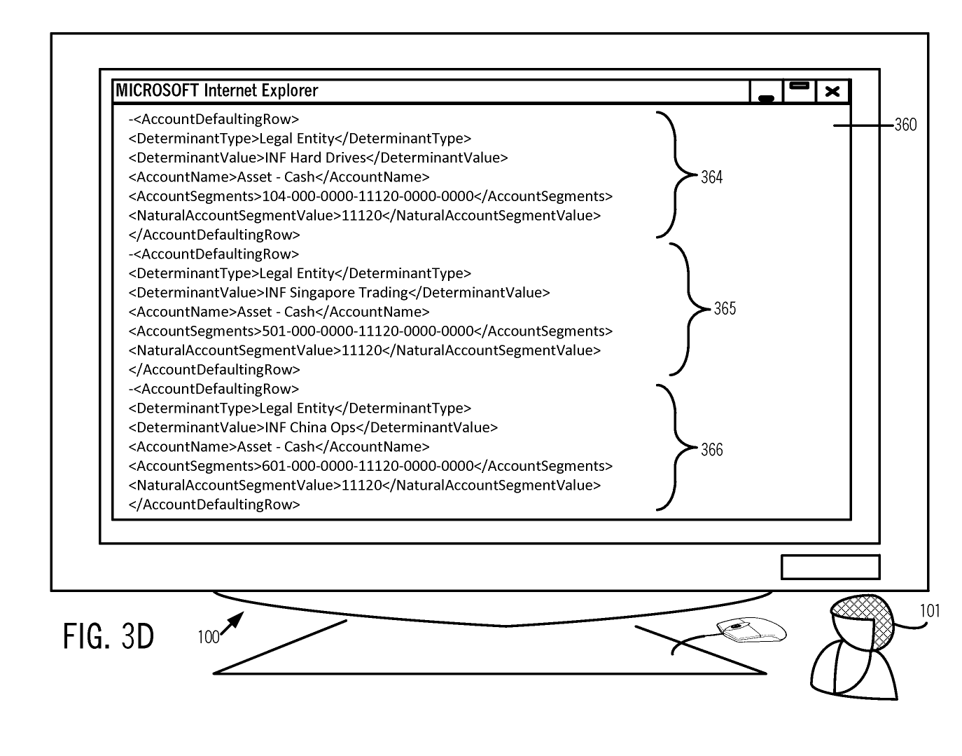

In some embodiments, one or more computers 100 execute the macro to use the account's name 211A with a map 220 (FIG. 2B) in an act 113A (performed within act 113), to lookup the level 222A (FIG. 2B) at which reports are to be run as “Ledger”. In such embodiments, the one or more computers 100 use the level in another act 113B (also performed within act 113 of FIG. 1), to obtain N values respectively identifying corporate entities at that level, by searching another spreadsheet. For example, searching spreadsheet 330 (FIG. 3A) using the ledger (or country) level, yields three countries namely “United States”, “Singapore” and “China” in column 331 which are uniquely identified in three rows 333, 334 and 335. Within these same three rows 333, 334 and 335, three cells in column 332 identify “101”, “501” and “601” respectively as three values (i.e. N=3) to be used by the one or more computers 100 to respectively identify corporate entities at the country (or ledger) level. Although column 331 has four cells identifying the country “United States” identically, only a first cell is used by the one or more computers 100, to uniquely identify countries (and to identify a single entity, within each country).

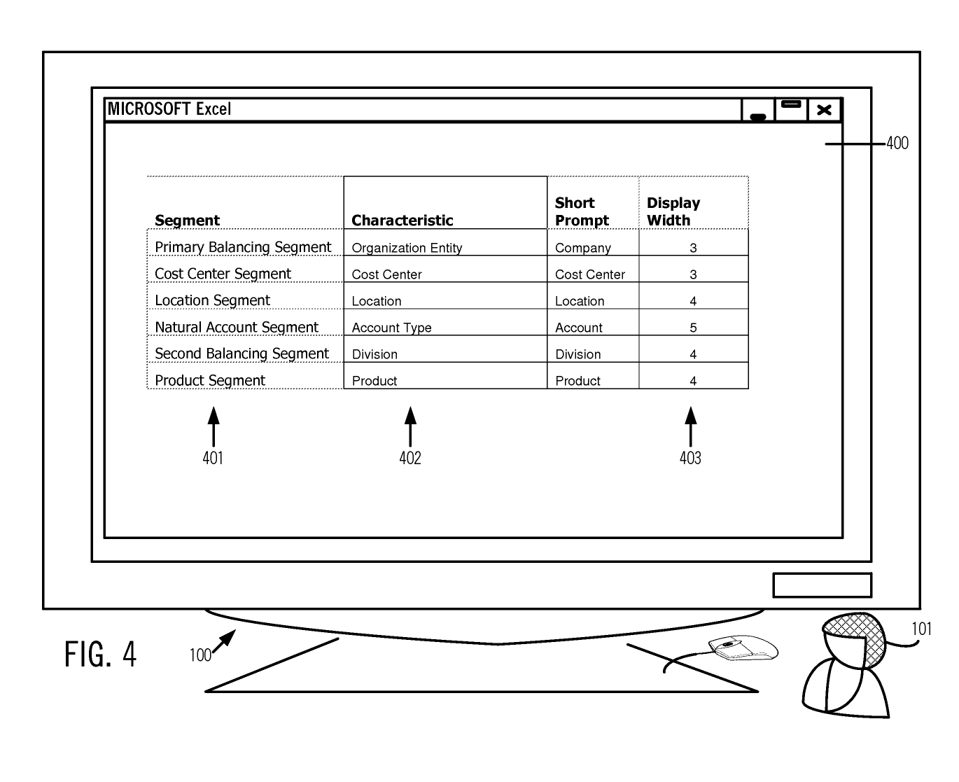

After act 113 (FIG. 1), the one or more computers 100 go to act 114 (via branch 116) to continue executing the macro to use a pattern of segments that defines an identifier of an account (“account ID”), to insert at least a specific value obtained in act 112 (which identifies the account uniquely among accounts of the specific type) into one segment of the pattern in a non-volatile memory (e.g. flash memory), and each of the N values obtained in act 113 (which identifies an organizational entity) into another segment of the pattern in the non-volatile memory, to obtain N account identifiers. In an illustrative example, a pattern of an identifier is defined by user input to have six segments, as illustrated by six rows in the spreadsheet 400 shown in FIG. 4, with corresponding six values therein separated from one another by a hyphen as follows: AAA-BBB-CCCC-DDDDD-EEEE-FFFF. In the just-described identifier, a three-digit value AAA is of a first segment named “Primary Balancing Segment” in the first row of column 401 (FIG. 4) identifies an entity of the organization as shown in the first row of column 402. Similarly, another three-digit value BBB is of a second segment named “Cost Center Segment” in the second row of column 401 (FIG. 4) identifies a cost center in the organization as shown in the second row of column 402.

Moreover, a four-digit value CCCC is of a third segment named “Location Segment” in the third row of column 401 (FIG. 4) identifies a location at which a transaction occurs, as shown in the third row of column 402. Furthermore, a five-digit value DDDDD is of a fourth segment named “Natural Account Segment” in the fourth row of column 401 (FIG. 4) identifies a type of account in which the transaction is recorded, as shown in the fourth row of column 402. Additionally, a four-digit value EEEE is of a fifth segment named “Second Balancing Segment” in the fifth row of column 401 (FIG. 4) identifies a sub-entity within the entity identified in the first segment, as shown in the fifth row of column 402. Finally, a four-digit value FFFF is of a sixth segment named “Product Segment” in the sixth row of column 401 (FIG. 4) identifies a product for which the transaction is recorded, as shown in the sixth row of column 402. Each of the segments identifies a characteristic of an accounting transaction recorded by accounting program 190.

In the above-described example, a first value among the three values “101”, “501” and “601” that identifies a single entity of the organization within each country (as obtained in act 113) is used in a first iteration of act 114 as the value AAA. Moreover, the specific value “31010” that identifies an account named “Retained Earnings” (received in act 112) is additionally used in the first iteration of act 114 as the value DDDDD. As the pattern includes additional segments, namely the second, third, fourth and sixth segments, default values (e.g. each digit 0) are inserted for these segments in act 114. A default value that is used for each additional segment is obtained in some embodiments by performing acts 118 and 119 (FIG. 1). Specifically, in act 118 the one or more computers 100 executing the macro check if there are any additional segments, and if no go to act 114 and if yes go to act 119. In act 119, the one or more computers 100 retrieve a default value from a first non-empty cell in a specific column of an additional spreadsheet for the additional segment, with user input being received therein on the default value. Hence, in the just-described example, a first iteration of act 114 results in identifier: 101-000-0000-31010-0000-0000.

In act 114, the just-described identifier is associated with a corresponding account name, e.g. the name “Retained Earnings” to form a tuple 351 (FIG. 3B). Depending on the embodiment, the tuple 351 may include labels, e.g. the account identifier 351I may be labeled with a first predetermined label (e.g. the label “AccountSegments” in opening and closing tags before and after the account identifier), and the account's name 351N labeled with a second predetermined label (e.g. the label “AccountName” in opening and closing tags before and after the account name). Some embodiments of tuple 351 include an account's type 351T in addition to the account's name 351N which is separated therefrom by a hyphen “-” as shown in FIG. 3B. As illustrated in FIG. 1, act 114 is repeated N−1 times. Hence, the second value “501” identifying another entity is used in a second iteration of act 114 to create the identifier: 501-000-0000-31010-0000-0000, which is used to form tuple 352 shown in FIG. 3B. Similarly, a third iteration of act 114 results in the identifier: 601-000-0000-31010-0000-0000 used to form tuple 353 shown in FIG. 3B.

Some embodiments store (as per act 115 in FIG. 1) each tuple in a document 350 that is expressed in an eXtended Markup Language (XML), and when all tuples are stored in document 350, document 350 is transmitted (also in act 115 in FIG. 1) from the one or more computers 100 to a server 150 (below). When all tuples are not stored in document 350, e.g. when additional user input is still to be processed in spreadsheet 210 of workbook 120, the one or more computers 100 return to act 111 (described above) to repeat the just-described method, e.g. to process user input naming additional accounts in additional rows of column 211 in spreadsheet 210 (FIG. 2A).

In a second iteration of act 111 in the example illustrated in FIG. 2A, the one or more computer(s) 100 receive the account's name 211B and the account's type 213B in row 214 and column 211 of spreadsheet 210 (FIG. 2A), e.g. the name “Cash” and the type “Asset” are received, as described above in reference to act 111. Also, in the second iteration of act 112, the one or more computer(s) 100 receive the specific value 212B in row 213 and column 212 of spreadsheet 210 in FIG. 2A, e.g. receive the specific value “11120”. As these user inputs are within the same row 214, the specific value “11120” is to be used by the one or more computers 100 to uniquely identify the account named “Cash”, e.g. among multiple accounts of type “Asset”. In a second iteration of act 113, the one or more computer(s) 100 use the account's name 211B with map 220 (described above, see FIG. 2B) to lookup a level 222B at which reports are to be run as “Legal Entity” and then use this level to search spreadsheet 330.

On doing so, the one or more computers 100 identify six (i.e. N=6) legal entities namely “INF Data Center”, “INF Support”, “INF Servers”, “INF Hard Drives”, “INF Singapore Ops” and “INF China Ops” in column 336 and corresponding thereto six values namely “101”, “102”, “103”, “104”, “601” and “501” in column 332 to be used to identify entities at the legal level. Hence, in a second iteration of act 114, the one or more computer(s) 100 use the six account names and the corresponding six values as described above to prepare six tuples 361-366 (FIGS. 3C and 3D). These six tuples are stored in document 350 in a second iteration of act 115, as described above. At this stage, based on user input in two rows 213 and 214 of spreadsheet 210, document 350 has been populated with three tuples 351-353 (i.e. N=3) and six tuples 361-366 (i.e. N=6) respectively.

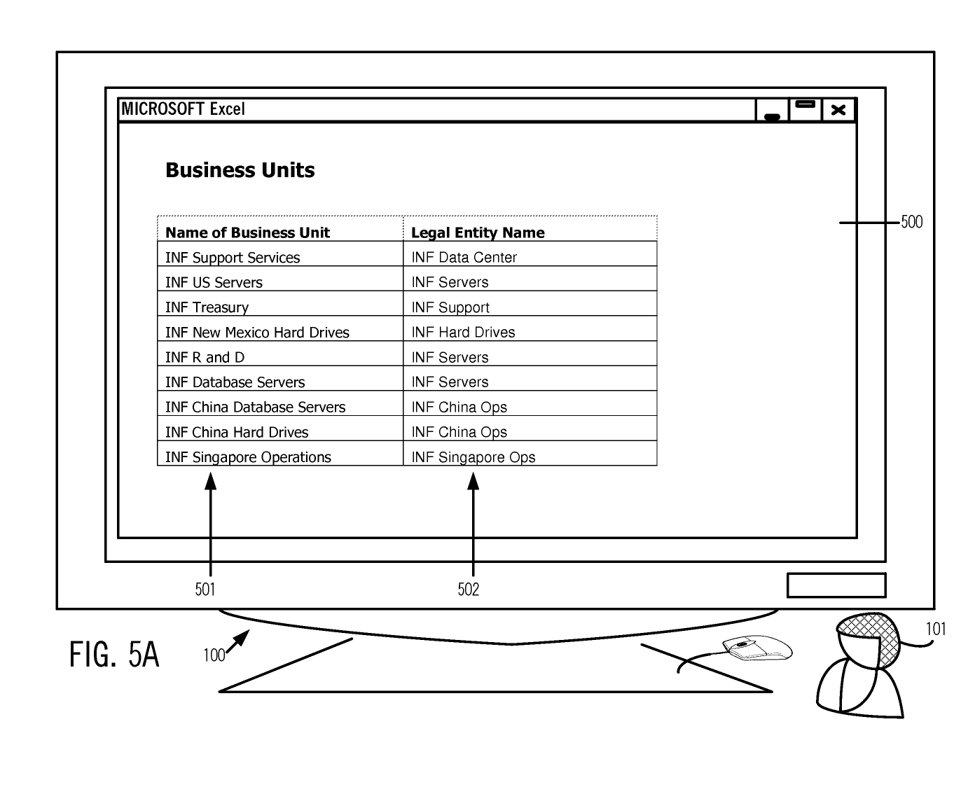

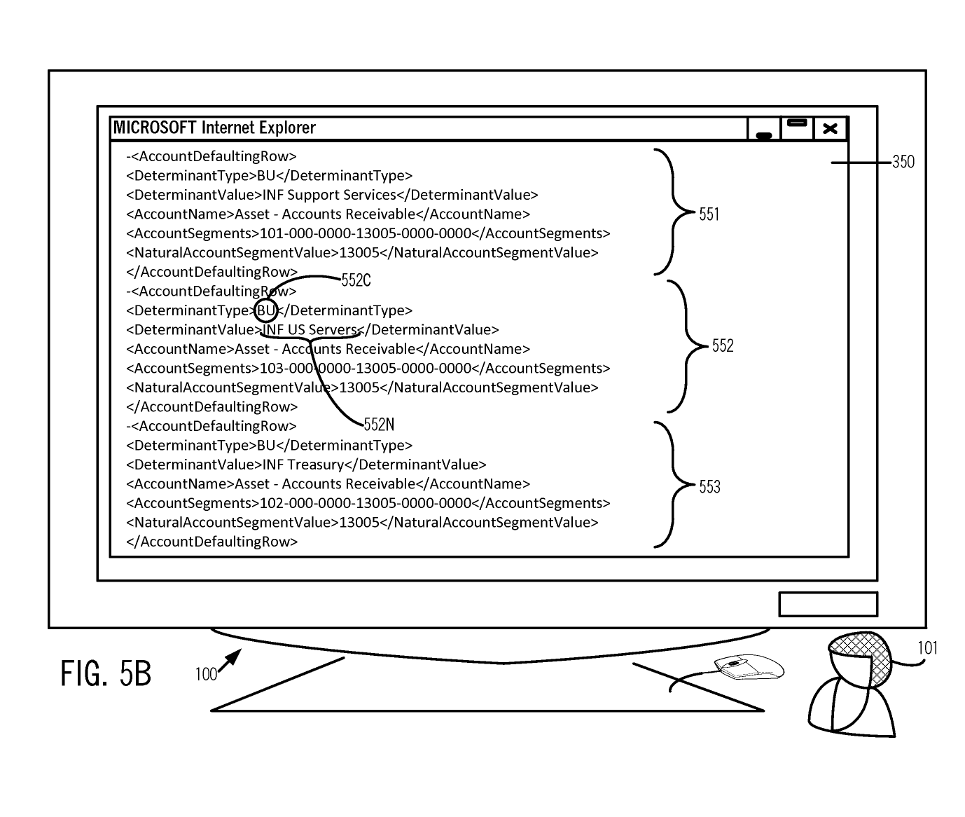

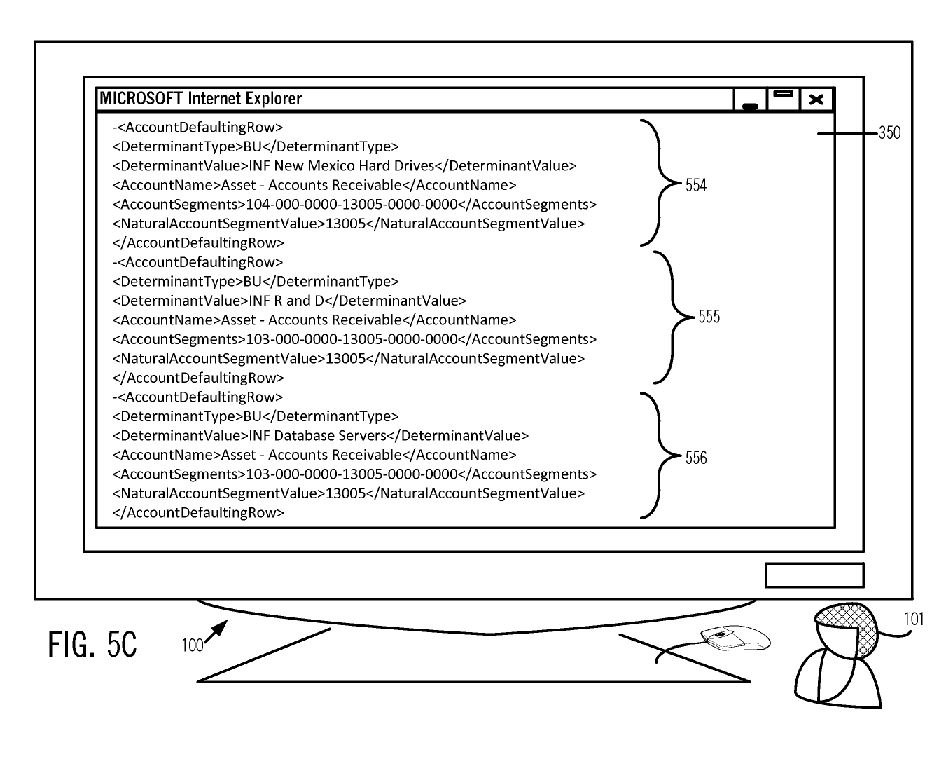

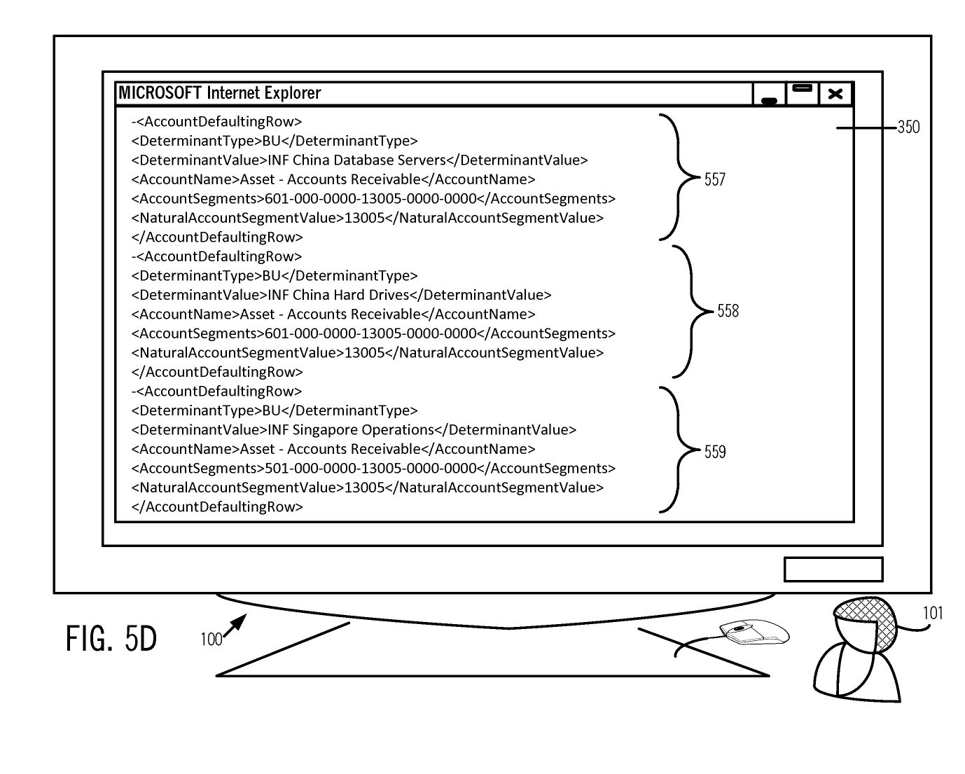

In the two iterations described above, although the same spreadsheet 330 is searched (at the “Ledger” level and the “Legal” level), other spreadsheets may be searched for other levels, as follows. For example, in a third iteration of act 111 in the example illustrated in FIG. 2A, the one or more computer(s) 100 receive the account's name 211C and the account's type 213C in row 215 and column 211 of spreadsheet 210 (FIG. 2A), e.g. the name “Accounts Receivable” and the type “Asset” are received, as described above in reference to act 111. Also, in the third iteration of act 112, the one or more computer(s) 100 receive the specific value 212C in row 213 and column 212 of spreadsheet 210 in FIG. 2A, e.g. receive the specific value “13005”. As these user inputs are within the same row 215, the specific value “13005” is to be used by the one or more computers 100 to uniquely identify the account named “Accounts Receivable”, e.g. among multiple accounts of type “Asset”. In a third iteration of act 113, the one or more computer(s) 100 use the account's name 211B with map 220 (described above, see FIG. 2B) to lookup level 222C at which reports are to be run as “Business Unit” (abbreviated as “BU”) and then use this level to search a spreadsheet 500 (FIG. 5A) that relates business units to legal entities. On doing so, the one or more computers 100 identify nine (i.e. N=9) business units (which are entities in the organization) namely “INF Support Services”, “INF US Servers”, “INF Treasury”, “INF New Mexico Hard Drives”, “INF R and D”, “INF Database Servers”, “INF China Database Servers”, “INF China Hard Drives”, “INF Singapore Operations” in column 501.

Next, each business unit's name is used by the one or more computers 100 to identify a legal entity in which the business unit is contained (e.g. in column 502 in spreadsheet 500 of FIG. 5), and each legal entity is then used to identify a corresponding value to be used in the first segment (e.g. in column 332 in spreadsheet 330). Specifically, the following nine values are identified: “101”, “103”, “102”, “104”, “103”, “103”, “601”, “601” and “501” in column 332 to be used to identify entities at the legal level. Hence, in a third iteration of act 114, the one or more computer(s) 100 use the nine account names and the corresponding nine values as described above to prepare nine tuples 551-559 (FIGS. 5B-5D). These nine tuples are stored in document 350 in a third iteration of act 115, as described above. At this stage, based on user input in three rows 213, 214 and 215 of spreadsheet 210, document 350 has been populated with a total of 18 tuples (Z=18), namely three tuples 351-353 (i.e. N=3), six tuples 361-366 (i.e. N=6) and nine tuples 551-559 (i.e. N=9). Although processing of user input in three rows 213, 214 and 215 (FIG. 2A) has been described above in three iterations, such processing may be repeated in additional iterations for any number of rows of user input, in spreadsheet 210.

As multiple business units may be included in a single legal entity, tuples for such multiple business units have the same value for the first segment, and hence the same account identifier. For example, the following three business units “INF US Servers”, “INF R and D” and “INF Database Servers” are all included in the legal entity “INF Servers”. Hence, the first segment in an identifier of the “Accounts Receivable” account of these three business units has a common value, namely the value 103. Additionally, the fourth segment named “Natural Account Segment” has another common value, namely the value “13005” which identifies the “Accounts Receivable” account uniquely among accounts of the type “Asset”. Thus, the same account identifier, namely 103-000-0000-13005-0000-0000 is included in tuples 552 (FIG. 5B), 555, 566 (FIG. 5C) for the three business units “INF US Servers”, “INF R and D” and “INF Database Servers” respectively.

Identical identifiers in tuples 552, 555, 566 of accounts having identical names (e.g. the name “Accounts Receivable”) are distinguished from one another in some embodiments by including in each tuple a level (which is used to identify an entity in the organization, by searching a spreadsheet), and a name of the entity at this level, optionally with labels applied thereto. For example, tuple 552 which contains the above-described account identifier namely 103-000-0000-13005-0000-0000 for the account named “Accounts Receivable” further includes “BU” as a level 552C of an organizational entity (the level being business unit) labeled using the label “DeterminantType”, and also includes “INF US Servers” as a name 552N of the organizational entity labeled using the label “DeterminantValue”. Accordingly, account identifier 103-000-0000-13005-0000-0000 for the account named “Accounts Receivable” is associated with one entity namely business unit “INF US Servers” in tuple 552 (FIG. 5B), while the identical account identifier 103-000-0000-13005-0000-0000 for the identically named account “Accounts Receivable” is associated with a different entity namely business unit “INF R and D” in tuple 555 (FIG. 5C). The names of entities in the tuples 552 and 555 being different from one another distinguish these two tuples that would otherwise be identical to one another. Depending on the embodiment, a tuple may separately include a value used in the account identifier, e.g. value “13005” of account type, labeled using a label “NaturalAccountSegmentValue.”

Referring to FIG. 1, in an act 151, server 150 receives document 350, retrieves Z tuples (e.g. Z=18) from document 350 and stores the Z tuples into corresponding Z rows of a table 141 (also called “tuples table”) in a relational database 140. Table 141 in relational database 140 is accessed by accounting program 190 via a relational database management system (RDBMS). Table 141 of some embodiments has at least the following columns: primary key, account name, account identifier, account type. Depending on the embodiment, table 141 may have additional columns, such as: business unit, legal entity, ledger and chart-of-accounts, with only one of these additional columns being populated based on information received in a tuple. As noted below in more detail, in an act 152, the Z tuples in table 141 are used by one or more modules in accounting program 190, to automatically set up Z accounts based on account names and account identifiers in the Z tuples. Creation of the Z tuples automatically eliminates the need for user 101 (FIG. 2A) to manually provide user input Z times for the Z accounts. Instead, user input is provided by user 101 just once for each of N tuples, N being variable (e.g. 3) depending on the level at which accounts are setup. N is smaller than Z by M times, M being an integer number indicative of how often act 114 (FIG. 1) is repeated, with M=6 in the example described above (as N=3 and Z=18). Depending on the number and type of entities in an organization and depending on the type of accounts, M can be one or two orders of magnitude, e.g. M can be 10 or 100.

In some embodiments, after the Z tuples are populated into table 141 (FIG. 1), initialization procedures in modules in accounting program 190 are automatically executed by server 150 in act 152 (FIG. 1), e.g. by invoking an application programming interface (API). Depending on the embodiment, the initialization procedures may be written in Java or PL/SQL. Examples of modules in accounting program 190 include an Accounts Receivable module 191, an Accounts Payable module 192, a General Ledger module 193, an Asset Management module 194, a Cash and Expense module 195, and a Payments & Collections module 196 (see FIG. 6B). On being invoked, each initialization procedure in a corresponding module of accounting program 190 searches tuples table 141 for rows containing predetermined names of accounts. For example, an initialization procedure in Accounts Receivable module searches tuples table 141 for any rows with the account name “Accounts Receivable.” In the above-described example, nine rows are found in tuples table 141 to have the name “Accounts Receivable” (which were populated by use of tuples 551-559 in act 151).

Thereafter, for each row found to have the predetermined account name, the initialization procedure in a corresponding module checks if a corresponding account already exists, e.g. by looking in a specific table used by the corresponding module to post transactions (also called “module-specific table”), for an account identifier in the row found in table 141) and if not creates the account (e.g. by adding to the module-specific table, a new row including, for example, the account identifier, the account type and the account name). If the initialization procedure finds on checking that the corresponding account already exits, no change is made to the module-specific table. In the above-described example, nine rows in tuples table 141 with the name “Accounts Receivable” are used by the initialization procedure to check (and if not found add) nine new rows (including, for example, account type, account name and account identifier) into an AR table 142 (FIG. 6B) that is used by the Accounts Receivable module 191 when processing transactions (e.g. creating invoices).

Subsequently, user 101 can verify that new accounts have been automatically setup, in module-specific tables used by corresponding modules to process transactions. In one example of accounting program 190, e.g. in ORACLE Fusion Accounts Receivable module therein, user 101 may navigate to Manage Receivables System Options page, query a Business Unit which is automatically created by accounting program 190 based on spreadsheet 500 (FIG. 5A), to view in a screen of a graphical user interface generated by accounting program 190, a display of accounts setup in the accounting program 190 and confirm consistency thereof with account type and account name combinations specified in spreadsheet 210 (FIG. 2A). In one such example, several accounts such as Revenue, Unearned Revenue, Accounts Receivable, Freight, Unbilled Receivables, Autoinvoice Clearing and Tax Payable are referenced as part of an initialization procedure, in the Accounts Receivables module.

In an illustrative example, with or without verification of new accounts, user 101 uses a screen in an Accounts Receivable module (or other module) in accounting program 190 to create an invoice (or other transaction) that stores entries in one or more new accounts setup as noted above. Specifically, user 101 opens a screen of a module in accounting program 190 to create an accounting transaction (e.g. an invoice), and on doing so the screen displays a field requiring user input to identify a business unit or a legal entity, and based on this user input, one or more accounts are automatically identified, by the module looking up its corresponding module-specific table (described above). Each module in accounting program 190 uses its own module-specific table in database 140 (see FIG. 6B) to process its transactions, e.g. Accounts Receivable module 191 uses an AR table 142, Accounts Payable module 192 uses an AP table 143, General Ledger module 193 uses a GL table 144, Asset Management module 194 uses an AM table 145, Cash and Expense module 195 uses a CE table 146, and Payments & Collections module 196 uses a PC table 147.

In one example, during creation of such a transaction, in addition to user input identifying the business unit or legal entity, additional user input is received on details of the transaction, such as date of the transaction, currency, type of transaction and/or source of transaction, payment terms, addresses for billing and/or shipping, as well as one or more lines of items sold (also called invoice lines). In the just-described example, when saving an invoice, accounts with the following names are automatically identified (by the Accounts Receivable module 191 looking up the AR table 142): Accounts Receivable, Freight, Revenue, and Tax (each of these accounts is of account type Asset). The just-described accounts are thereafter displayed to user 101 in a screen, in corresponding rows, each row including at least the account identifier and account name. On receiving user input to store the transaction, the information therein is automatically transferred to the General Ledger module 193, through a subledger accounting engine, to generate accounting entries in the General Ledger, and generating journal entries as needed. Examples of journal entries are: Debit Receivables, Credit Revenue, Credit Tax (if tax is charged), and Credit Freight (if freight is charged). A posting process then updates account balances in the General Ledger.

Database 140 of some embodiments is implemented as a relational database which is accessible by executing software of a relational database management system (RDBMS), such as Oracle 11gR2 available from Oracle Corporation of Redwood Shores, Calif. In some embodiments, computer(s) 100 used by user 101 to provide user input are mobile devices, such as smartphones, and/or other electronic devices that can receive user input and provide a display, such as a watch. Moreover, act(s) performed by an account ID generator 110 illustrated in FIG. 1 may be used to program one or more computer(s) 100 each of which may be implemented as illustrated in FIG. 6A and discussed below. Thus, depending on the embodiment, one or more computer(s) 100 and/or server 150 may be programmed to perform one or more or all of acts illustrated in FIG. 1 in whole or in part, and in any combination with one or more hardware components described below and illustrated in FIG. 6A. In the description below, server 150 is referred to as computer 150.

In some embodiments, each of computer(s) 100, 150 includes a bus 1102 (FIG. 6A) or other communication mechanism for communicating information, and one or more processor(s) 1105 coupled with bus 1102 for processing information. Each of computer(s) 100, 150 uses (as the above-described memory) a main memory 1106, such as a random access memory (RAM) or other dynamic storage device, or any non-transitory computer readable storage media coupled to bus 1102 for storing information and instructions (e.g. to perform act(s) of FIG. 1) to be executed by processor(s) 1105.

Main memory 1106 (FIG. 6A) also may be used for storing temporary variables or other intermediate information during execution of instructions (e.g. in components 110, 190 illustrated in FIGS. 6B and 6C) by processor 1105. Each of computer(s) 100, 150 further includes a read only memory (ROM) 1104 or other static storage device coupled to bus 1102 for storing static information and instructions for processor 1105, such as software in the form of a browser. A storage device 1110, such as a magnetic disk or optical disk, is provided and coupled to bus 1102 for storing information and instructions.

Each of computer(s) 100, 150 (FIG. 6A) may be coupled via bus 1102 to a display device or video monitor 1112 such as a cathode ray tube (CRT) or a liquid crystal display (LCD), for displaying information (e.g. via a browser) to a computer user (e.g. user 111) on the display 1112. An input device 1114, including alphanumeric and other keys (e.g. of a keyboard), is coupled to bus 1102 for communicating information (such as user input, e.g. from any user 111) to processor 1105. Another type of user input device is cursor control 1113, such as a mouse (described above), a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane. In addition to display device 1112 on which output (FIGS. 2A, 2B, 3A-3D, 4 and 5A-5D) may be displayed, computer(s) 200 may include a speaker (not shown) as another output device for use by processor 1105 in interacting with any user(s) (such as user 101).

As described elsewhere herein, execution of account ID generator 110 (FIG. 1) in computer(s) 100 (FIG. 6A) and accounting program 190 in computer 150 may be implemented by one or more processor(s) 1105 executing one or more sequences of one or more instructions that are contained in main memory 1106. Such instructions may be read into main memory 1106 from another non-transitory computer readable storage medium, such as storage device 1110. Execution of the sequences of instructions contained in main memory 1106 causes processor 1105 to create, store and update tuples as illustrated in FIG. 1 and/or to display screens as illustrated in FIGS. 2A, 2B, 3A-3D, 4 and 5A-5D. In alternative embodiments, hard-wired circuitry may be used in place of or in combination with software instructions to perform act(s) illustrated in FIG. 1.

The term “non-transitory computer readable storage media” as used herein refers to any non-transitory storage media that store information in any non-transitory manner, and may be configured to provide to processor 1105, a plurality of instructions for execution. One or more such non-transitory storage media may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110, to store program code in the form of instructions and/or data structures and that can be accessed by computer(s) 200. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer(s) 100, 150 can receive information about a change to a collaboration object on the telephone line and use an infra-red transmitter to transmit the information in an infra-red signal. An infra-red detector can receive the information carried in the infra-red signal and appropriate circuitry can place the information on bus 1102 (FIG. 6A). Bus 1102 carries the information to main memory 1106, from which processor 1105 retrieves and executes the instructions. The instructions received by main memory 1106 may optionally be stored on storage device 1110 either before or after execution by processor 1105.

Each of computer(s) 100, 150 also includes a communication interface 1115 (FIG. 6A) coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 (FIG. 6A) typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer(s) 100, 150 are exemplary forms of carrier waves transporting the information.

Each of computer(s) 100, 150 (FIG. 6A) can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations of FIG. 1 may be executed by processor 1105 as they are received, and/or stored in storage device 1110, or other non-volatile storage for later execution. In this manner, computer(s) 100, 150 may additionally or alternatively obtain instructions and any related data.

FIG. 6A is a very low-level representation of many hardware components of one or more of computer(s) 100, 150 described above in reference to FIG. 1. Several embodiments have one or more additional software components 110, 190 in main memory 1106 as shown in FIG. 6B. In addition to main memory 1106, each of computer(s) 100, 150 may include one or more other types of memory such as flash memory (or SD card) and/or a hard disk and/or an optical disk (also called “secondary memory”) to store data and/or software for loading into memory 1106 (also called “main memory”) and/or for use by processor(s) 1105. In some embodiments, one or more of computer(s) 100, 150 implement a relational database management system 1130 (FIG. 6B) to manage data in one or more tables of a relational database 140 of the type illustrated in FIG. 6B. Such a relational database management system may manage a distributed database system that includes multiple databases, each table being stored on different storage mechanisms.

In some embodiments, the multiple databases are made to appear as a single database. In such embodiments, processor 1105 can access and modify the data in a relational database 140 via RDBMS 1130 (FIG. 6B) that accepts queries from various software components 110, 190 in conformance with a relational database language, the most common of which is the Structured Query Language (SQL). The commands are used by processor 1105 of some embodiments to store, modify and update tuples in the form of rows in a table 141 in relational database 140.

Relational database management system 1130 (FIG. 6B) further includes output logic that makes the data in a database table of relational database 140 available to a user via a graphical user interface that generates a screen on a video monitor display 1112, such as the screens illustrated in FIGS. 2A, 2B, 3A-3D, 4 and 5A-5D. In one example, the output logic of one or more of computer(s) 100, 150 provides output via a web-based user interface that depicts in a browser of another computer, information related to tuples and/or accounts generated therefrom. Additionally and/or alternatively, screens responsive to user input via a keyboard as a command in a command-line interface of computer(s) 100, 150 and/or user input via a mouse and a cursor displayed on a video monitor may be generated by computer(s) 100, 150.

In some embodiments of one or more of computer(s) 100, 150, functionality in the above-described operations or acts of FIG. 1 is implemented by processor 1105 (FIG. 7A) executing software in memory 1106, although in other embodiments such functionality is implemented in any combination of hardware circuitry and/or firmware and/or software in one or more of computer(s) 100, 150. Depending on the embodiment, various functions of the type described herein may be implemented in software (executed by one or more processors or processor cores) or in dedicated hardware circuitry or in firmware, or in any combination thereof. Accordingly, depending on the embodiment, any one or more of the means for performing operations or acts of FIG. 1 can, but need not necessarily include, one or more microprocessors, embedded processors, controllers, application specific integrated circuits (ASICs), digital signal processors (DSPs), multi-core processors and the like, appropriately programmed with software in the form of instructions to implement one or more steps of the type described herein.

Any non-transitory computer-readable medium tangibly embodying software (also called “computer instructions”) may be used in implementing one or more acts or operations described herein and illustrated in FIG. 1. Such software may include program codes stored in memory 1106 and executed by processor 1105 (FIG. 6A). Memory 1106 may be implemented within or external to processor 1105, depending on the embodiment. When implemented in firmware and/or software, logic to perform one or more acts or operations of FIG. 1 may be stored as one or more computer instructions or code on a non-transitory computer-readable medium.

In some embodiments, one or more of computer(s) 100, 150 may include multiple processors, each of which is programmed with software in a memory 1106 shared with each other to perform acts of the type described above to implement the individual components illustrated in FIGS. 6B and 6C. For example, a first processor 1105 in one or more of computer(s) 100, 150 may be programmed with software in memory 1106 to implement acts 111-115 and 118, 119 of FIG. 1 in a component 110. A second processor 1105 in one or more of computer(s) 100, 150 may be programmed with software in memory 1106 (FIG. 6A) to implement acts 151 and 152 of FIG. 1 in a component 190. Depending on the embodiment component 110 (namely, an account ID generator) may be implemented external to component 190 (namely, an accounting program as illustrated in FIG. 6B) or internal to component 190 (as illustrated in FIG. 6C), or partly internal and partly external as will be apparent to a skilled artisan.

Although two processors 1105 (FIG. 6A) have been just described for some embodiments to implement the respective means, in other embodiments a single processor 1105 may be used in a time shared manner to implement the just-described means of the previous paragraph. For example, a server that executes accounting program 190 may also execute spreadsheet software to receive user inputs in acts 111 and 112 described above. Such a server may be programmed to perform any one or more of acts 113-115, 118 and 119 as described above in reference to FIG. 1. Moreover, in such embodiments, one processor 1105 may be used in a time-shared manner to implement one or more parts of various components of the type described herein. For example, one or more processors 1105 may be programmed to implement one or more components 110, 190 or any portions thereof. Furthermore, although processors 1105 have been described above for certain embodiments as being included in a single computer, in other embodiments multiple such processors 1105 may be included in multiple computers, for example two computers 100, 150 may implement any one or more of acts 111-115, 118, 119, 151 and 152 described above in reference to FIG. 1.

Various adaptations and modifications may be made without departing from the scope of the described embodiments. Numerous modifications and adaptations of the embodiments described herein are encompassed by the attached claims.

1. A method to improve setup of a server that executes an accounting program, the method comprising:
one or more computers or the server receiving a name of an account of a specific type to be setup in the accounting program;
the one or more computers or the server receiving a specific value to be used to identify the account uniquely, among accounts of the specific type;
the one or more computers or the server using the name of the account to automatically obtain N values that respectively identify N entities of an organization;
the one or more computers or the server repeatedly using a pattern of segments defining an identifier that is segmented, at least by inserting the specific value into one segment of the pattern and one of the N values into another segment of the pattern, to obtain N identifiers;
the one or more computers or the server storing N tuples in a table in a non-transitory memory, each of the N tuples being stored in a row of the table, the table comprising a first column for the identifier of the account and a second column for the name of the account; and
the server executing at least one initialization procedure, to set up N accounts in the accounting program, based on the N tuples.

2. The method of claim 1 comprising:
the one or more computers using the name of the account with a map, to identify a level of the organization;
the one or more computers using the level to search a spreadsheet to identify the N values.

3. The method of claim 2 wherein:
the one or more computers or the server store in multiple tuples, identifiers of accounts identical to one another, and names of accounts identical to one another;
the one or more computers or the server further store in each of the multiple tuples, at least a name of an entity in the organization at said level, the names of entities in the multiple tuples being different from one another.

4. The method of claim 1 wherein:
the name of the account and a type of the account are both received in a single cell, in a first predetermined column and in a specific row of a spreadsheet; and
the specific value to be used to identify the account is received via another cell in a second predetermined column and in the specific row of the spreadsheet.

5. The method of claim 4 wherein:
the first predetermined column is labeled in the spreadsheet as a type of account.

6. The method of claim 1 wherein the table is hereinafter a tuples table, the tuples table being comprised in a database in the server, the accounting program comprising an Accounts Receivable module, and the database comprising an AR table, the method further comprising:
the server executing an initialization procedure in the Accounts Receivable module to use a row in the tuples table to check and if not found add a new row in the AR table.

7. One or more non-transitory computer readable storage media comprising a plurality of instructions executable by one or more processors to improve setup of a server that executes an accounting program, the plurality of instructions comprising:
instructions to one or more computers or the server to receive a name of an account of a specific type to be setup in the accounting program;
instructions to the one or more computers or the server to receive a specific value to be used to identify the account uniquely, among accounts of the specific type;
instructions to the one or more computers or the server to use the name of the account to automatically obtain N values that respectively identify N entities of an organization;
instructions to the one or more computers or the server to repeatedly use a pattern of segments defining an identifier that is segmented, at least by inserting the specific value into one segment of the pattern and one of the N values into another segment of the pattern, to obtain N identifiers;
instructions to the one or more computers or the server to store N tuples in a table in a non-transitory memory, each of the N tuples being stored in a row of the table, the table comprising a first column for the identifier of the account and a second column for the name of the account; and
instructions to the server to execute at least one initialization procedure, to set up N accounts in the accounting program, based on the N tuples.

8. The one or more non-transitory computer readable storage media of claim 7 wherein plurality of instructions comprise:
instructions to the one or more computers to use the name of the account with a map, to identify a level of the organization;
instructions to the one or more computers to use the level to search a spreadsheet to identify the N values.

9. The one or more non-transitory computer readable storage media of claim 8 wherein:
the one or more computers or the server store in multiple tuples, identifiers of accounts identical to one another, and names of accounts identical to one another;
the one or more computers or the server further store in each of the multiple tuples, at least a name of an entity in the organization at said level, the names of entities in the multiple tuples being different from one another.

10. The one or more non-transitory computer readable storage media of claim 8 wherein:
the name of the account and a type of the account are both received in a single cell, in a first predetermined column and in a specific row of a spreadsheet; and
the specific value to be used to identify the account is received via another cell in a second predetermined column and in the specific row of the spreadsheet.

11. The one or more non-transitory computer readable storage media of claim 10 wherein:
the first predetermined column is labeled in the spreadsheet as a type of account.

12. The one or more non-transitory computer readable storage media of claim 8 wherein the table is hereinafter a tuples table, the tuples table being comprised in a database in the server, the accounting program comprising an Accounts Receivable module, and the database comprising an AR table, the plurality of instructions further comprising:
instructions to the server executing an initialization procedure in the Accounts Receivable module to use a row in the tuples table to check and if not found add a new row in the AR table.

13. A system comprising one or more processors coupled to one or more non-transitory storage media comprising instructions executable by the one or more processors to improve setup of a server that executes an accounting program, the system being configured to:
receive a name of an account of a specific type to be setup in the accounting program;
receive a specific value to be used to identify the account uniquely, among accounts of the specific type;
use the name of the account to automatically obtain N values that respectively identify N entities of an organization;
repeatedly use a pattern of segments defining an identifier that is segmented, at least by inserting the specific value into one segment of the pattern and one of the N values into another segment of the pattern, to obtain N identifiers;
store N tuples in a table in a memory, each of the N tuples being stored in a row of the table, the table comprising a first column for the identifier of the account and a second column for the name of the account; and
execute at least one initialization procedure, to set up N accounts in the accounting program, based on the N tuples.

14. The system of claim 13 wherein the system is configured to:
use the name of the account with a map, to identify a level of the organization;
use the level to search a spreadsheet to identify the N values.

15. The system of claim 13 wherein:
the one or more processors or the server store in multiple tuples, identifiers of accounts identical to one another, and names of accounts identical to one another;
the one or more processors or the server further store in each of the multiple tuples, at least a name of an entity in the organization at said level, the names of entities in the multiple tuples being different from one another.

16. The system of claim 13 wherein:
the name of the account and a type of the account are both received in a single cell, in a first predetermined column and in a specific row of a spreadsheet; and
the specific value to be used to identify the account is received via another cell in a second predetermined column and in the specific row of the spreadsheet.

17. The system of claim 16 wherein:
the first predetermined column is labeled in the spreadsheet as a type of account.

18. The system of claim 13 wherein the table is hereinafter a tuples table, the tuples table being comprised in a database in the server, the accounting program comprising an Accounts Receivable module, and the database comprising an AR table, the system being further configured to:
execute an initialization procedure in the Accounts Receivable module to use a row in the tuples table to check and if not found add a new row in the AR table.
